(19) United States
(12) Patent Application Publication
(10) Pub. No.: US 2024/0289784 A1
(43) Pub. Date: Aug. 29, 2024

(54) TIERED CONSENSUS

(71) Applicant: nChain Licensing AG, Zug (CH)

(72) Inventors: Craig Steven WRIGHT, London (GB); Chloe TARTAN, London (GB); Kattharine MOLLOY, London (GB)

(21) Appl. No.: 18/573,645

(22) PCT Filed: May 25, 2022
(86) PCT No.: PCT/EP2022/064165

§ 371 Date: Dec. 22, 2023

(30) Foreign Application Priority Data
Jun. 25, 2021 (GB) 2109195.4

(51) Int. Cl. G06Q 20/38; G06Q 20/02

(52) U.S. Cl. CPC G06Q 20/38215; G06Q 20/02; G06Q 20/3825

(57) ABSTRACT

A computer-implemented method of using a multi-level, ML, blockchain protocol to reach consensus on a data chain using a core blockchain, wherein the method comprises: obtaining a target data block associated with the data chain; generating a target ML block of the ML blockchain, wherein the target ML block is a respective core blockchain transaction and comprises a) the target data block, and b) a target chain output, wherein the target chain output is configured to be spent by a respective chain input of a subsequent ML block and comprises a locking script configured to implement a respective consensus-based locking mechanism, wherein the respective consensus-based locking mechanism of each respective ML block is a function of the respective data block of that respective ML block, and c) a target chain input that references the respective chain output of a previous ML block.

### CROSS REFERENCE TO RELATED APPLICATIONS

This application is the U.S. National Stage of International Application No. PCT/EP2022/064165 filed on May 25, 2022, which claims the benefit of United Kingdom Patent Application No. 2109195.4, filed on Jun. 25, 2021, the contents of which are incorporated herein by reference in their entireties.

### TECHNICAL FIELD

The present disclosure relates to a method of reaching consensus on data of a data chain using a multi-level (i.e. tiered) data chain protocol.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

### SUMMARY

It is recognised herein that a blockchain that utilises a UTXO-based transaction model can be used as a carrier of a secondary data chain. In some examples, the secondary data chain may be a secondary blockchain (i.e. a blockchain other than the one acting as the carrier). This may be beneficial if an existing, secondary blockchain or its network becomes unviable, e.g. due to lack of hash power. For instance, units of a digital currency coins held by the secondary network's users may be preserved by embedding the secondary blockchain within the viable, core blockchain. An alternative scenario may be where the owners of a private blockchain require proofs of data integrity. This can be achieved by embedding the private data in its raw form or as a cryptographic commitment within a public, core blockchain as an immutable record of the data. In other examples, the secondary data chain may be non-blockchain related and in general may be any data structure where the data is arranged as a chain, e.g. an append-only log. Examples of such data structures include communication chains (e.g. an email or text message chain), move-ordered games (e.g. chess), etc. By using the core blockchain as a carrier of the secondary data chain, the secondary chain inherits the advantages of the core blockchain including, amongst other things, immutability, traceability, transparency, and security of data.

According to one aspect disclosed herein, there is provided a computer-implemented method of using a multi-level, ML, blockchain protocol to reach consensus on a data chain using a core blockchain, wherein the ML blockchain comprises one or more previous ML blocks, wherein each previous ML block is a respective core blockchain transaction and comprises a) a respective data block associated with the data chain, and b) a respective chain output, wherein the respective chain output is configured to be spent by a respective chain input of a subsequent ML block and comprises a locking script configured to implement a respective consensus-based locking mechanism that can be unlocked by any one or more of a plurality of ML block producers, and wherein the method is performed by a ML block producer and comprises: obtaining a target data block associated with the data chain; generating a target ML block of the ML blockchain, wherein the target ML block is a respective core blockchain transaction and comprises a) the target data block, and b) a target chain output, wherein the target chain output is configured to be spent by a respective chain input of a subsequent ML block and comprises a locking script configured to implement a respective consensus-based locking mechanism, wherein the respective consensus-based locking mechanism of each respective ML block is a function of the respective data block of that respective ML block, and c) a target chain input that references the respective chain output of a previous ML block and is configured to unlock the respective consensus locking mechanism of that previous ML block; and causing the target ML block to be recorded on the core blockchain.

The term “multi-level” (ML) protocol refers to the protocol that structures a secondary data chain as a higher-level chain of data above (i.e. using) the underlying core blockchain (i.e. the first level blockchain). The data chain may be interpreted as a second level blockchain, as it comprises blocks of data (i.e. the ML blocks) in the form of core transactions of the first level blockchain. Note that even in examples where the secondary data chain is itself not a blockchain (e.g. a communication chain), the secondary data is still structured (i.e. embedded) on the core blockchain using blocks, which are referred to as ML blocks. According to the ML protocol, a ML block is a core blockchain transaction. Each ML block (core blockchain transaction) comprises a data block, i.e. a chunk of data, associated with a secondary data chain. For example, each data block may be an entry (or set of entries) in an off-chain database, a message in a communication chain, a turn in a move-ordered game, a bank transfer or payment made by a user, a trade made by a financial institution, etc. The data block may or may not be in an encrypted form, e.g. hashed using a hash function.

An ML block also includes a chain input and a chain output, which are used to chain ML blocks together, which is analogous to how block headers of the core blockchain are used to chain core blocks together. The chain input and chain outputs utilize a consensus mechanism to lock and unlock the core blockchain transactions that represent the ML blocks. A consensus locking mechanism is a locking mechanism that is configured such that it can be unlocked by any one or more of a plurality of ML block producers. In this way, the ML block producers are able to come to a consensus, i.e. agreement, on the data block comprised by the ML block that is being unlocked. In some examples, the consensus locking mechanism is function of the data block. For example, the consensus locking mechanism may comprise a proof-of-work puzzle that comprises a hash of the data block. The ML protocol enacts a tiered consensus, whereby the ML block producers come to a consensus on the data blocks in the ML blocks, and the core nodes of the core blockchain network come to a consensus of the ML blocks (core blockchain transactions).

To summarise, a chain of core blockchain transactions acts as a chain of blocks of the ML data chain (or ML blockchain). Each ML block includes embedded data of the secondary data chain, e.g. secondary blockchain.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions, and

FIG. 5 schematically illustrates an example system for implementing a multi-level blockchain protocol.

### DETAILED DESCRIPTION OF EMBODIMENTS

### 1. Example System Overview

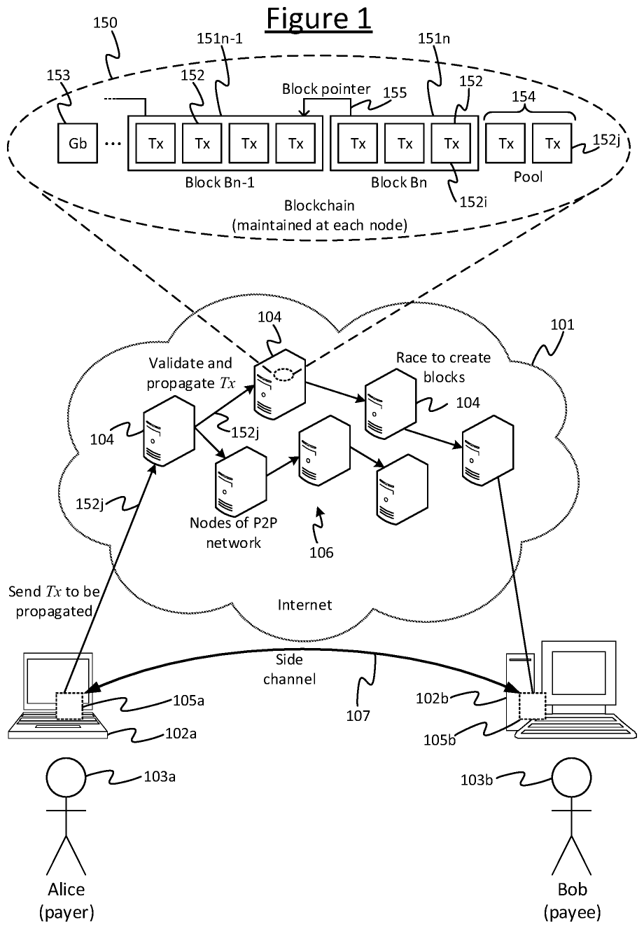

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

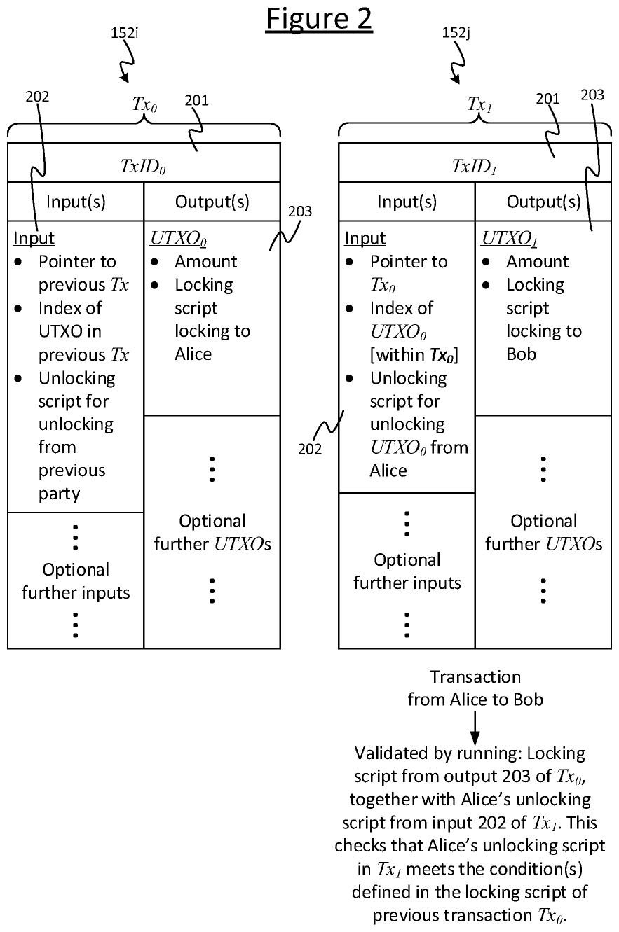

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} > < {P}_{A} > ‖ [ Checksig {P}_{A} ]$$

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Client Software

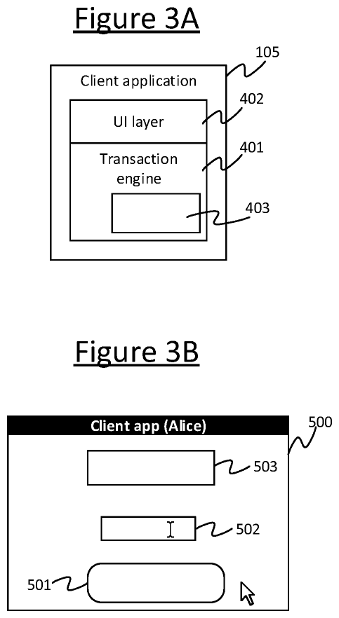

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 comprises a function 403 . . . .

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to . . . .

Alternatively or additionally, the UI elements may comprise one or more data entry fields 502, through which the user can . . . . These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### 5. Node Software

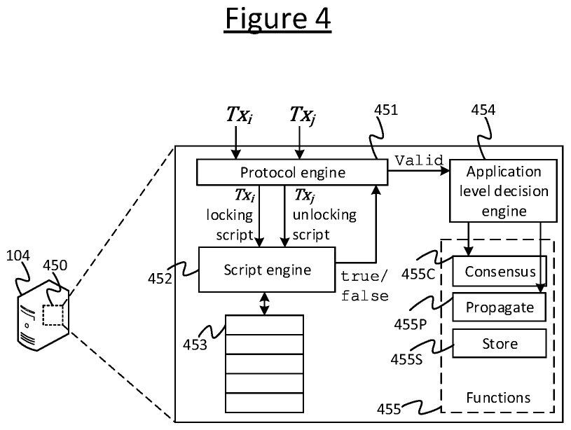

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Tx)) is received having an input pointing to an output (e.g. UTXO) of another, preceding transaction 152i (Txₘ₋₁), then the protocol engine 451 identifies the unlocking script in Tx and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 6. Core Blockchain Example

This section describes an example of a core (i.e. first tier) blockchain that may be used as a carrier of a secondary data chain according to embodiments of the present invention. Note that these examples are for illustrative purposes only.

### 6.1 Core Transactions

A transaction is a message that comprises inputs and outputs, which are typically used to transfer the ownership or control of amounts of a digital asset from one set of addresses to another.

The example fields correspond to the following information:
Version: A 4-byte integer which has no function or restrictions on its value.
Inputs: An array of transaction inputs, each comprising of the following sub-fields:
   Outpoint: A structure identifying the UTXO being spent, comprising:
      TxID: The 32-byte transaction identifier TxID for the UTXO being spent.
      Index: The 4-byte output index n for the UTXO being spent.
   Unlocking script: The script which, when combined with the locking script for the input, validates the coin to be spent.
   nSeq: A 4-byte integer that defaults to 0xFFFFFFFF. Values less than this default (maximum) indicate that this transaction may not be final and can be superseded by a transaction that spends the same input and has a higher sequence number. The transaction is considered final when all sequence numbers have been set to the maximum, or when the locktime is reached.
Outputs: An array of transaction outputs, each comprising of the following sub-fields:
   Value: An 8-byte integer that indicates the value (in Satoshis) of the output.
   Locking script: The locking script, which contains the conditions that must be met to spend the coin
Locktime: A 4-byte integer that defaults to 0. Values greater than 0 enforce a delay, indicating the earliest time at which the transaction may be included in a block, either by block height (for values<500,000,000) or by UNIX time otherwise.

### 6.2 Data Outputs

Within a core blockchain transaction, one or more outputs may contain one or more opcodes that enable a data payload to be included in the output. For example an OP_RETURN code may be followed by some data (in the form of a string). The opcode is placed at the end of the unlocking script, which allows transactions to serve as data carriers without disrupting the signature validation process. When a data transaction is published on the blockchain, there exists an immutable record of the data that is embedded in the output. OP_RETURN codes can either be preceded by OP_FALSE (0), which renders the UTXO that is created by the output unspendable (i.e. it does not need to be stored by full nodes in the UTXO set), or used without OP_FALSE to create a spendable UTXO. Other opcodes may be used to place data in an output, e.g. OP_PUSH and OP_DROP.

### 6.3 Core Blocks

A block is a data structure containing a set of transactions and some additional fields related to how a block is appended to the longest chain (i.e. the chain with the most proof-of-work). The fields of an example block are as follows:
Block header: A structure giving the information about how and when a block was mined, and what it contains. This comprises the following six sub-fields:
   Version: A 4-byte integer indicating the set of protocol rules used for block validation.
   Hash of Previous Block Header: A 32-byte SHA-256 double hash of the previous block header.
   Merkle root: A 32-byte SHA-256 double hash derived from the Merkle tree of transactions.
   Timestamp: A 4-byte integer encoding the Unix time at which a block producer generated the header.
   Difficulty Target: A 4-byte integer encoding the target difficulty required for the block to be mined.
   Nonce: A 4-byte integer chosen to achieve a block header hash of the required difficulty.
Transactions: A structure detailing the transactions within the block. It comprises:
   Transaction Count: An integer of variable length indicating the number of transactions contained within the block.
   Transaction List: A structure containing transaction data for the full list of transactions included in a block. The first transaction in this list is always the coinbase transaction (see below).

### 7. Tiered Consensus

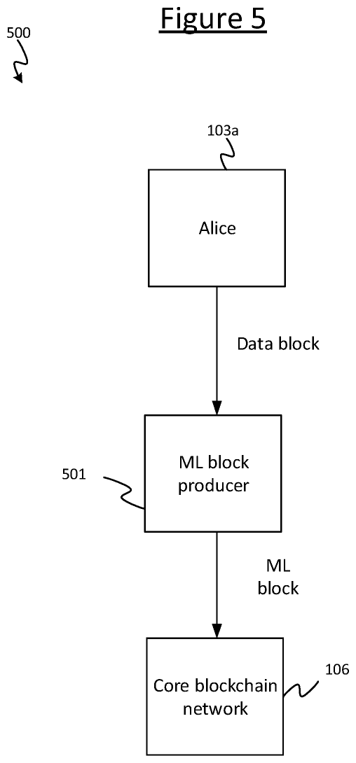

FIG. 5 illustrates an example system 500 for implementing a multi-level (ML) blockchain protocol. The system 500 may comprise one or more entities configured to submit data blocks to an ML block producer 501. For instance, system 500 may comprise one or more users, e.g. Alice 103a and Bob 103b, each being configured to generate and submit data blocks to the ML block producer. It will be appreciated that the system 500 may comprise any number of users. Note also that the entities configured to submit data blocks to the ML block producer 501 need not be users in the sense of a human operating a device. That is, one or more of such entities may be machines, smart contracts, or the like. The ML block producer 501 is configured to receive and/or generate data blocks, and to generate ML blocks, i.e. core blockchain transactions. The ML block producer 501 is also configured to submit ML blocks to the core blockchain network 106. The ML block producer 501 may be a blockchain node 104 of the core blockchain network 106. That is, the ML block producer 501 may be configured to generate both ML blocks and core blockchain blocks 151. In these examples, the ML block producer may generate a core block comprising one or more ML blocks, and submit that core block to the core network 106. In other examples, the ML block producer may be a simplified payment verification (SPV) client application, i.e. a client application configured to implement the SPV method. The skilled person will be familiar with the SPV method. It is also not excluded that the ML block producer may be a user, e.g. Alice 103a. That is, a user 103 may generate ML blocks and submit them to the blockchain network 106. The system 500 may comprise multiple ML block producers 501.

The ML blockchain protocol is used to embed data associated with a data chain (a “secondary data chain”), e.g. a secondary blockchain, using transactions of a core blockchain. Data associated with the secondary data chain (e.g. secondary blockchain transactions) is embedded in the output of a core blockchain transaction, which is interpreted as a block of the ML blockchain. The data may be encrypted. Each data block comprises a piece, chunk, entry, etc. of the secondary data chain.

The ML block producer 501 is configured to generate a ML block based on the obtained (e.g. received) data blocks. That is, the ML block producer 501 is configured to construct a ML block (which is a core blockchain transaction), where each ML block comprises one of the obtained data blocks. The data block may be placed in an output of the ML block, e.g. in the first output of the ML block. The ML block includes a chain output that is used to chain ML blocks. The chain output may be the output that appears logically first in the ML block, although this is not essential. In some examples, the chain output may comprise the data block. The ML block also includes a chain input that references and unlocks a chain output of the previous ML block in the ML blockchain. Again, the chain output may be the input that appears logically first in the ML block. The chain output is configured to implement a consensus-based locking script. More details of the consensus-based locking script are provided below.

The ML block producer 501 is configured to cause the ML block to be recorded on the core blockchain as a core blockchain transaction. Depending on the capabilities of the ML block producer 501, this may involve including the ML block in a core block of the core blockchain. Additionally or alternatively, the ML block producer 501 may submit the ML block to one or more nodes of the core blockchain network 106.

In some examples, each ML block (i.e. core blockchain transaction) may comprise a flag or other such identifier that enables block producers 501 and/or users to identify ML blocks. The flag identifier, or such like may be included in an output (e.g. the chain output) of the ML block. Additionally or alternatively, the ML block may comprise a particular version number (e.g. a 4-byte integer) that is known to be associated with the ML protocol.

Returning now to the consensus-based locking mechanism, each chain output comprises a locking script that is configured such that is can be unlocked by any one or more of a plurality of ML block producers 501. In some examples, the plurality of ML block producers 501 may be predefined. In other examples, the plurality of ML block producer 501 may not be predefined.

The consensus mechanism of a given ML block is a function of the data block of the corresponding ML block. In other words, the locking script that enforces the consensus mechanism is based on the data block. As mentioned above, ML blocks are chained together via the chain inputs and chain outputs. That is, a chain input of the n^{th} ML block spends the chain output of n−1^{th} block, and the chain input of the n+1^{th} block spends the chain output of the n^{th} block. In these embodiments, the chaining of ML blocks is based on the secondary data itself. Note that “spends” does not not necessarily imply transfer of a currency or financial asset, and more generally an input may consume an output (where spending is an example of consuming).

In some examples each chain output may comprise a puzzle, and each chain input may comprise a solution that solves the puzzle of the chain output being spent. The puzzle may be a proof-of-work (POW) hash puzzle. That is, the locking script of a given chain output may be configured to enforce a PoW hash puzzle. This is analogous as to how some core blockchains require a PoW puzzle to be solved in order to append a new core block. The PoW hash puzzle of a given ML block is a function of the data block of that ML block and a target difficulty. The skilled person will be familiar with the concept of PoW hash puzzles and a target difficulty per se. The target difficulty may be the same for every ML block, or it may be changed in order to make it easier or harder to solve the hash puzzle, which in turn affects the rate at which new ML blocks may be added to the ML chain. More specifically, the PoW hash puzzle of a given ML block is a function of the data block of that ML block, e.g. a function of a data block hash (i.e. a hash of the data block). The PoW hash puzzle is configured to take, as an input from a chain input of the next ML block, a data block hash of the next ML block (i.e. a hash of the data block of the next ML block), combine (e.g. concatenate) the data block hash of the current ML block with the data block hash of the next ML block, and determine whether a hash of the combination meets the difficulty target. Depending on the specific PoW hash puzzle, this may comprise determining whether the hash of the combination is less than (or less than or equal) to the difficulty target, which is itself a number. The PoW hash puzzle is configured such that the locking script will only unlock if the difficulty target is satisfied.

In these examples, when constructing a new ML block the ML block producer 501 must find a data block hash (a “solution”) that, when processed by the POW puzzle of the previous ML block, satisfies the difficulty target of the current ML block which is set by and placed in the locking script of the previous ML block. In order to find such a solution, the ML block producer 501 may modify part of the data block such that the difficulty target will be satisfied when the data block hashes are combined and hashed. The part of the data block that is modified may be a nonce value. For instance, the ML block producer 501 may iterate through a sequence of nonce values until finding a nonce value that results in a solution to the PoW hash puzzle.

This PoW consensus mechanism is similar to that used by some core blockchain networks. For example, the PoW system used in the Bitcoin blockchain requires block producers to solve a hash puzzle: they must find a candidate block where the hash of the block header is below a certain value (the difficulty target, D). This type of hash puzzle can be represented in-script as follows:

$$< BlockHeader > OP\_SHA256 < D > OP\_LESSTHAN$$

A similar script can be used to enforce the POW puzzle of the consensus mechanism described above. For each ML block, the chain input references a chain output (sometimes referred to as an outpoint) of the previous ML block. This previous chain output has a locking script that contains a hash puzzle based on the previous secondary data block. In order to unlock the previous chain output, the ML block producer 501 must provide a value that is based on their current secondary data block and satisfies the hash puzzle placed in the previous ML block to be solved by the current ML block. The following conditions in the chain output of each ML block (created at height h) ensure the validity of the ML chain:

| | |
|---|---|
| 1. | Outpoint references the chain output (i.e. UTXO) of the previous |
| | ML block, MLBₕ₋₁. |
| 2. | Unlocking script is set to the hash of the current secondary data |
| | block: <H(DataBlockₕ)> |
| 3. | Output sets the new locking script: |
| | < H(DataBlockₕ)> OP_CAT OP_SHA256 < D > OP_LESSTHAN |
| | where D is the current difficulty target of the secondary chain. |

With these conditions, when validating the chain output of MLBₕ, the unlocking script is concatenated with the locking script of index 0 of MLBₕ₋₁, giving:

$$< H ( {DataBlock}_{h} ) > < H ( {DataBlock}_{h - 1} ) \text{} > OP\_CAT OP\_SHA256 < D > OP\_LESSTHAN$$

This combined script will be evaluated as true if:

$$H ( H ( {DataBlock}_{h} ) ‖ H ( {DataBlock}_{h - 1} ) ) < D$$

In the PoW system for Bitcoin, for example, only the current block header is included explicitly in the validity condition. However, the relationship to the previous block is implicitly enforced because each block header contains the hash of the previous block header. This would also be the case for the secondary block data, but an additional layer of chaining is enforced via the ML protocol. In the ML protocol, the hash puzzle that builds the chain between neighbouring blocks also serves as a locking script for a UTXO. It is important to have a unique value as part of each locking script puzzle, otherwise any value that is known to have a hash below the difficulty target can be used to spend the UTXO. All previous data block hashes where the same—or a harder—difficulty target was in use will have this property, and a malicious actor could use any of these to spend the UTXO, breaking the UTXO chain. To resolve this vulnerability, the ML protocol explicitly includes the value of the most recent secondary data block hash in each locking script. This value is unpredictable and ensures a solution can only be found by applying hash power.

The difficulty target is set according to the ML protocol rules and may be varied according to the combined hash power being invested into ML block production. Note that the in-script puzzle above requires two hash operations for each iteration of the PoW calculations: the current data block must be hashed, concatenated with a fixed value, H(DataBlockₕ₋₁), and hashed a second time. The first hash is not strictly necessary, but it reduces the size of the unlocking script and therefore the ML transaction fee. If this extra hash operation is used, the secondary chain difficulty target can also be adjusted to compensate.

As an alternative to the PoW hash puzzle described above, each ML block may comprise, in its chain output, a POW R-puzzle. R-puzzles are used to prove knowledge of an ephemeral key k that is used to derive the r value of a ECDSA signature:

r=[R]ₓ where R=k·G mod n=(x,y)

The ephemeral key is independent of the public-private keypair but is a critical security parameter in ECDSA signatures. They are designed for single use to prevent compromise of a private key. The main features of R-puzzles are:
1. they allow users to use any public-private keypair when solving the knowledge proof,
2. an extra signature is typically used to prevent signature forgeability by anyone that intercepts the proof, and
3. they offer an alternative to P2PKH or hash puzzles in script.

A POW r-puzzle requires a spender to not only solve the r-puzzle, but also do work to find a value (e.g., nonce) that results in a hash value below a certain difficulty target D. Following the same logic described above for the PoW hash puzzle to chain consecutive UTXOs, the Pow r-puzzle facilitates a check of the below equation in script:

$$H ( H ( {r}_{h} ‖ {DataBlock}_{h} ) ‖ H ( {r}_{h - 1} ‖ {DataBlock}_{h - 1} ) ) < D$$

A puzzle is created based on the r value of the ECDSA signature for ease of computation but a puzzle based on R can also be covered. The chain output of a ML block may comprise a locking script as follows:

OP_DUP OP_3 OP_SPLIT OP_NIP OP_1 OP_SPLIT OP_SWAP OP_SPLIT OP_DROP
OP_2 OP_ROLL OP_CAT OP_SHA256 [symbol] H(rₕ ∥ DataBlockₕ) [symbol] OP_CAT OP_SHA256 [symbol]
D [symbol] OP_LESSTHAN OP_VERIFY
OP_OVER OP_CHECKSIGVERIFY OP_CHECKSIG

The chain input of the next ML block (at height h+1) comprises an unlocking script as follows:

$$〈 {sig}^{′} 〉 〈 P 〉 〈 {DataBlock}_{h + 1} 〉 〈 {sig}_{{r}_{h + 1}} 〉$$

The signature sig, uses the required r value. P is the ML block producer's public key. The extra signature sig′ is based on a different r value and is added for security reasons as stated above: it prevents malicious nodes from forging a signature that unlocks the R-puzzle without actual knowledge of the r value in the signature sig=(r,s). In some examples, this additional signature is not required.

The first line in the locking script extracts r. The second line constructs the left-hand side of the PoW equation. The third line checks that the condition on the right-hand side of the PoW equation holds. The fourth line carries out signature verification checks on both signatures in the unlocking script.

It will be appreciated that the above locking script is just one example of how a POW r-puzzle may be implemented. More generally, the POW r-puzzle comprises a first hash value and a difficulty target. The first hash value is a hash of the data block of the current ML block concatenated with an r value. The POW r-puzzle is configured to take, as an input from a chain input of the next ML block, a data block of the next ML block and a signature. The POW r-puzzle is configured to extract the r value from the signature, combine (e.g. concatenate) the extracted r-value with the data block of the next ML block, and generate a second hash value by hashing the combined r value and data block. The Pow puzzle is also configured to check that a hash of the combination (e.g. concatenation) of the first and second hash values meets the difficulty target.

Alternative methods for chaining, or reaching consensus over a chain of, the ML blocks may be used. For instance, a given chain output of an ML block may be locked to a public key associated with a threshold private key. This may be enforced using a pay-to-public-key-hash (P2PKH) locking script. Each of a set of ML block producers may have a share of the threshold private key, requiring a threshold number of the plurality of ML block producers 501 to contribute in order to generate a valid signature and therefore to append a new ML block to the chain. More specifically, to validate the chain output (and thus the ML block), a threshold number of ML block producers who hold key shares must agree that the ML block is valid. Assuming the ML block producer who submits their candidate ML block for peer approval provides their signature share, then a 2-of-n threshold scheme would require the approval of at least one authorised peer in the secondary network for the block to be valid. Schemes with higher thresholds would require the approval of more than one peer to validate a ML block.

As another example, a given chain output of an ML block may comprise a multi-signature locking script locked to two or more of a plurality of public keys. That is, each chain output may comprise a multi-signature spending condition with a 2-of-n requirement, allowing a valid signature to be created by any two or more of the n private keys that correspond to the list of public keys. This means a group of approved parties (i.e. ML block producers) can be established, where at least two of which are required to add a new linked transaction to the UTXO chain, and thus a new ML block to the ML chain.

Each of the described consensus mechanisms is a function of the respective data block included in the respective ML block that contains the consensus mechanism (in the form of a locking script). This ensures that the locking script always enforces a ‘consensus’ on the data. For example, the PoW puzzle and POW r-puzzle enforced by the locking script of a previous ML block require a hash of the respective data block of the current ML block to be included in the chain input of that ML block. For signature-based consensus mechanisms, the signature is a function of the data block. That is, a sighash flag may be used that forces the signature to sign an output comprising the data block (i.e. SINGLE, S| ACP, ALL, ALL|ACP), e.g. all outputs (ALL, ALL|ACP). This ensures that the data block (no matter which output it is in) is included in the signature message. For threshold signatures, each party must sign exactly the same data (using the same sighash flags) for the combination of signature shares to be valid. The sighash flag may be set such that the signature is forced to sign the data. For multi-signature mechanisms, different sighash flags may be used, with the locking script being such that each party must use a certain sighash flag which signs the data block.

Each chain output may implement the same consensus mechanism, i.e. a particular type of locking mechanism which differs only in the specific data but not in the format or function of the locking script. For example, each chain output may comprise a locking script configured to implement the same consensus mechanism in the form of a PoW puzzle. Each PoW puzzle is unique in the sense that at least some of the data (e.g. hash of the previous block header, and the current block header) is specific to a given ML block, but the format of the locking script (e.g. the opcodes) is the same. As another example, in the case of a P2PKH locking script, the format is the same but the public key hash included in each locking script will be different.

As mentioned above, the data block may comprise the raw data or may be encrypted or otherwise encoded. This may be done to hide the raw data (e.g. if the data is private or sensitive) and/or to reduce the size of the data. As one option, the raw data (i.e. the secondary data from the secondary data chain) may be hashed before it is embedded in an ML block. Note that if only a hash of the secondary data is embedded, users may also choose to submit the preimage of the hashed data to the ML block producer. That way, the ML block producer can verify the embedded data hashes to the provided hash. While the hashing method reduces the burden of storage on the core chain, there is a trade-off in ease of data retrieval since secondary chain data can no longer be read directly from the core chain database. Instead, ML block producers are responsible for storing and maintaining the full secondary data chain (e.g. database).

In some embodiments, the secondary data chain is a secondary blockchain, i.e. a blockchain other than the core blockchain. The secondary blockchain may be the same type of blockchain as the core blockchain (i.e. a UTXO-based blockchain), or a different type of blockchain (e.g. an account-based blockchain). In these embodiments, each data block may comprise one or more blocks of the secondary blockchain. Preferably, each data block consists of a single block of the secondary blockchain. In other examples, each data block may comprise one or more transactions of the secondary blockchain. These embodiments may bestow on the secondary blockchain data advantages associated with the core blockchain that are not present in the secondary blockchain. These advantages will depend on the particular secondary blockchain but may include, inter alia, faster block propagation and/or validation, low transaction fees, data integrity, security via proof-of-work, immutability, etc.

However it should be appreciated that the secondary data chain can take forms other than a blockchain. In general, the secondary data chain may be any data structure where data is added in blocks, chunks, pieces, or entries, etc. In some examples, the secondary data chain is a chain of application specific data. The application may be a communication application, such as an (instant) messaging application, or an email application. In other examples, the application may be a game. In other examples, the application may be an image application, whereby photographs or other images are added to a gallery, or the like.

Regardless of the particular form of the secondary data chain, once published on the core chain, the ML block provides a public, immutable record of the secondary data chain. Each data block embedded from the secondary chain has a unique identifier on the core chain; the block height and TxID of the ML block that contains the embedded block.

In practice, the ML block producer is likely to be a node of the core network. However, in at least some embodiments the ML block producer may be an simplified payment verification (SPV) client or a user. SPV clients and users may have less capabilities compared to a blockchain node, e.g. not being able to submit core blocks to the core network, or validate core transactions (ML blocks) according to the core chain protocol as they would need access to the UTXO set for this. So in these embodiments, SPV clients would need a method of regularly checking the UTXO set of the core blockchain so as to validate core transactions. The SPV client may have a communication channel with a node for this purpose. In some examples, it is not necessary for the SPV client to validate the transactions, as the transactions will be validated by a core node and rejected if invalid.

If the ML block producer is a user e.g., Alice, she would not need access to the UTXO set but instead a way to identify the tip of the UTXO chain (i.e. the ML data chain) that is relevant to the secondary data chain (e.g. a particular application). This may be performed by querying the UTXO set or communicating with any other authorised users for that chain, or a core node.

The ML block producer is preferably able to identify the UTXO chain tip, i.e. the most recent valid ML block. If it is locked to a single P2PKH this is easy as the user knows no one else could have authorised a core transaction in the UTXO chain. This is also straightforward for nodes because they have a full copy of the blockchain history (which includes a mempool and UTXO set). However, for an SPV client performing PoW, or in situations where one party or a subgroup within a larger group can authorise a core transaction, the SPV client may need to be aware of the UTXO chain tip and any missing preceding ML blocks, e.g. if the client has been offline and has not received those ML blocks. The SPV client may request the most recent ML block(s) from a node.

### 8. Conclusion

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of using a multi-level, ML, blockchain protocol to reach consensus on a data chain using a core blockchain, wherein the ML blockchain comprises one or more previous ML blocks, wherein each previous ML block is a respective core blockchain transaction and comprises a) a respective data block associated with the data chain, and b) a respective chain output, wherein the respective chain output is configured to be spent by a respective chain input of a subsequent ML block and comprises a locking script configured to implement a respective consensus-based locking mechanism that can be unlocked by any one or more of a plurality of ML block producers, and wherein the method is performed by a ML block producer and comprises:
obtaining a target data block associated with the data chain;
generating a target ML block of the ML blockchain, wherein the target ML block is a respective core blockchain transaction and comprises a) the target data block, and b) a target chain output, wherein the target chain output is configured to be spent by a respective chain input of a subsequent ML block and comprises a locking script configured to implement a respective consensus-based locking mechanism, wherein the respective consensus-based locking mechanism of each respective ML block is a function of the respective data block of that respective ML block, and c) a target chain input that references the respective chain output of a previous ML block and is configured to unlock the respective consensus locking mechanism of that previous ML block; and
causing the target ML block to be recorded on the core blockchain.

Statement 2. The method of statement 1, wherein the respective chain output of each respective ML block comprises a same type of consensus-based locking mechanism.

Statement 3. The method of statement 2, wherein the respective consensus-based locking mechanism comprises a respective proof-of-work (PoW) puzzle, wherein the respective PoW puzzle comprises a respective hash of at least the respective data block, and a respective difficulty target, and wherein the POW puzzle is configured to require the respective chain input of the subsequent ML block to comprise a respective hash of at least the respective data block of the subsequent ML block, such that when executed, the PoW puzzle is configured to hash a combination of the respective hashes and require a resulting hash value to satisfy the respective difficulty target.

Statement 4. The method of statement 3, wherein the respective hash of at least the respective data block of the subsequent ML block comprises a hash of at least the respective data block of the subsequent ML block and a respective nonce value.

Statement 5. The method of statement 4, comprising determining a target nonce value that results in a target hash value that satisfies the respective difficulty target of the PoW puzzle of the previous ML block referenced by the target chain input.

Statement 6. The method of statement 2, wherein the respective consensus-based locking mechanism comprises a respective POW r-puzzle, wherein the respective POW r-puzzle comprises a respective first hash value and a respective difficulty target, wherein the respective first hash value is generated by hashing a hash of at least the respective data block combined with a respective r-value, where the respective r-value is a respective component of a digital signature, and wherein the POW r-puzzle is configured to require the respective chain input of the subsequent ML block to comprise i) a respective hash of at least the data block of the subsequent ML block and ii) a respective signature that uses the respective r-value, and wherein POW r-puzzle is configured to, when executed, extract the respective r-value from the signature, generate a respective second hash value by hashing the respective hash of at least the respective data block of the subsequent ML block combined with the extracted r-value, and require a resulting hash value to satisfy the respective difficulty target.

Statement 7. The method of statement 6, wherein the respective hash of at least the respective data block of the subsequent ML block comprises a hash at least the respective data block of the subsequent ML block and a respective nonce value.

Statement 8. The method of statement 7, comprising determining a target nonce value that results in a target hash value that satisfies the respective difficulty target of the POW r-puzzle of the previous ML block referenced by the target chain input.

Statement 9. The method of statement 1, wherein the respective consensus-based locking mechanism of each respective ML block comprises a multi-signature locking script locked to one or more of a predetermined set of public keys.

The multi-signature locking script may be locked to two or more of the predetermined set of public keys.

Statement 10. The method of statement 1, wherein the respective consensus-based locking mechanism of each respective ML block requires a respective signature corresponding to a respective threshold private key, wherein at least two different signature shares produced by different respective ML block producers are required to generate the respective signature.

Statement 11. The method of any preceding statement, wherein the chain output comprises the respective data block.

In some examples, any signatures included in the respective chain input that unlocks the respective chain output of the previous ML block must use a sighash flag (e.g. SINGLE, SINGLE|ACP, ALL, ALL|ACP) that signs the respective chain output that comprises the respective data block.

Statement 12. The method of any of statements 1 to 10, wherein the respective data block is part of a different output compared to the respective chain output.

In some examples, any signatures included in the respective chain input that unlocks the respective chain output of the previous ML block must use a sighash flag (e.g. ALL, ALL|ACP) that signs the output that comprises the respective data block.

Statement 13. The method of any preceding statement, wherein said causing of the target ML block to be recorded on the core blockchain comprises submitting the target ML block to the core blockchain network.

Statement 14. The method of any preceding statement, wherein said causing of the target ML block to be recorded on the core blockchain comprises submitting a core block to the core blockchain network, wherein the core block comprises the target ML block.

Statement 15. The method of any preceding statement, wherein said obtaining of the target data block comprises receiving the target data block.

Statement 16. The method of any preceding statement, wherein said obtaining of the target data block comprises generating the target data block.

Statement 17. The method of any preceding statement, wherein the target data block is encrypted.

Statement 18. The method of statement 17, wherein the target data block is encrypted using a hash function.

Statement 19. The method of any preceding statement, wherein the data chain is a secondary blockchain, and wherein each respective data block comprises a blockchain transaction of a secondary blockchain.

Statement 20. The method of any of statements 1 to 18, wherein the respective data comprises application-specific data.

E.g. data related to a specific communication or messaging application, e.g. an email application or social media application.

Statement 21. The method of any preceding statement, wherein the ML block producer is a blockchain node of the core blockchain.

Statement 22. The method of any of statements 1 to 20, wherein the ML block producer is not a blockchain node of the core blockchain.

Statement 23. The method of statement 22, wherein the ML block producer is a simplified payment verification client.

Statement 24. Computer equipment comprising:
memory comprising one or more memory units; and
processing apparatus comprising one or more processing units, wherein the memory stores code arranged to run on the processing apparatus, the code being configured so as when on the processing apparatus to perform the method of any preceding statement.

Statement 25. A computer program embodied on computer-readable storage and configured so as, when run on one or more processors, to perform the method of any of statements 1 to 23.

1. A computer-implemented method of using a multi-level, ML, blockchain protocol to reach consensus on a data chain using a core blockchain, wherein the ML blockchain comprises one or more previous ML blocks, wherein each previous ML block is a respective core blockchain transaction and comprises a) a respective data block associated with the data chain, and b) a respective chain output, wherein the respective chain output is configured to be spent by a respective chain input of a subsequent ML block and comprises a locking script configured to implement a respective consensus-based locking mechanism that can be unlocked by any one or more of a plurality of ML block producers, and wherein the method is performed by a ML block producer and comprises:
obtaining a target data block associated with the data chain;
generating a target ML block of the ML blockchain, wherein the target ML block is a respective core blockchain transaction and comprises a) the target data block, and b) a target chain output, wherein the target chain output is configured to be spent by a respective chain input of a subsequent ML block and comprises a locking script configured to implement a respective consensus-based locking mechanism, wherein the respective consensus-based locking mechanism of each respective ML block is a function of the respective data block of that respective ML block, and c) a target chain input that references the respective chain output of a previous ML block and is configured to unlock the respective consensus locking mechanism of that previous ML block; and
causing the target ML block to be recorded on the core blockchain.

2. The method of claim 1, wherein the respective chain output of each respective ML block comprises a same type of consensus-based locking mechanism.

3. The method of claim 2, wherein the respective consensus-based locking mechanism comprises a respective proof-of-work (PoW) puzzle, wherein the respective PoW puzzle comprises a respective hash of at least the respective data block, and a respective difficulty target, and wherein the PoW puzzle is configured to require the respective chain input of the subsequent ML block to comprise a respective hash of at least the respective data block of the subsequent ML block, such that when executed, the PoW puzzle is configured to hash a combination of the respective hashes and require a resulting hash value to satisfy the respective difficulty target.

4. The method of claim 3, wherein the respective hash of at least the respective data block of the subsequent ML block comprises a hash of at least the respective data block of the subsequent ML block and a respective nonce value.

5. The method of claim 4, comprising determining a target nonce value that results in a target hash value that satisfies the respective difficulty target of the PoW puzzle of the previous ML block referenced by the target chain input.

6. The method of claim 2, wherein the respective consensus-based locking mechanism comprises a respective POW r-puzzle, wherein the respective POW r-puzzle comprises a respective first hash value and a respective difficulty target, wherein the respective first hash value is generated by hashing a hash of at least the respective data block combined with a respective r-value, where the respective r-value is a respective component of a digital signature, and wherein the POW r-puzzle is configured to require the respective chain input of the subsequent ML block to comprise i) a respective hash of at least the data block of the subsequent ML block and ii) a respective signature that uses the respective r-value, and wherein POW r-puzzle is configured to, when executed, extract the respective r-value from the signature, generate a respective second hash value by hashing the respective hash of at least the respective data block of the subsequent ML block combined with the extracted r-value, and require a resulting hash value to satisfy the respective difficulty target.

7. The method of claim 6, wherein the respective hash of at least the respective data block of the subsequent ML block comprises a hash at least the respective data block of the subsequent ML block and a respective nonce value.

8. The method of claim 7, comprising determining a target nonce value that results in a target hash value that satisfies the respective difficulty target of the POW r-puzzle of the previous ML block referenced by the target chain input.

9. The method of claim 1, wherein the respective consensus-based locking mechanism of each respective ML block comprises a multi-signature locking script locked to one or more of a predetermined set of public keys.

10. The method of claim 1, wherein the respective consensus-based locking mechanism of each respective ML block requires a respective signature corresponding to a respective threshold private key, wherein at least two different signature shares produced by different respective ML block producers are required to generate the respective signature.

11. The method of claim 1, wherein the chain output comprises the respective data block.

12. The method of claim 1, wherein the respective data block is part of a different output compared to the respective chain output.

13. The method of claim 1, wherein said causing of the target ML block to be recorded on the core blockchain comprises submitting the target ML block to a core blockchain network.

14. The method of claim 1, wherein said causing of the target ML block to be recorded on the core blockchain comprises submitting a core block to a core blockchain network, wherein the core block comprises the target ML block.

15-18. (canceled)

19. The method of claim 1, wherein the data chain is a secondary blockchain, and wherein each respective data block comprises a blockchain transaction of a secondary blockchain.

20. The method of claim 1, wherein the respective data comprises application-specific data.

21. (canceled)

22. The method of claim 1, wherein the ML block producer is not a blockchain node of the core blockchain.

23. The method of claim 22, wherein the ML block producer is a simplified payment verification client.

24. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of using a multi-level, ML, blockchain protocol to reach consensus on a data chain using a core blockchain, wherein the ML blockchain comprises one or more previous ML blocks, wherein each previous ML block is a respective core blockchain transaction and comprises a) a respective data block associated with the data chain, and b) a respective chain output, wherein the respective chain output is configured to be spent by a respective chain input of a subsequent ML block and comprises a locking script configured to implement a respective consensus-based locking mechanism that can be unlocked by any one or more of a plurality of ML block producers, and wherein the method is performed by a ML block producer and comprises:
obtaining a target data block associated with the data chain;
generating a target ML block of the ML blockchain, wherein the target ML block is a respective core blockchain transaction and comprises a) the target data block, and b) a target chain output, wherein the target chain output is configured to be spent by a respective chain input of a subsequent ML block and comprises a locking script configured to implement a respective consensus-based locking mechanism, wherein the respective consensus-based locking mechanism of each respective ML block is a function of the respective data block of that respective ML block, and c) a target chain input that references the respective chain output of a previous ML block and is configured to unlock the respective consensus locking mechanism of that previous ML block; and
causing the target ML block to be recorded on the core blockchain.

25. A computer program embodied on non-transitory computer-readable storage media and configured so as, when run on one or more processors, the one or more processors perform a method of using a multi-level, ML, blockchain protocol to reach consensus on a data chain using a core blockchain, wherein the ML blockchain comprises one or more previous ML blocks, wherein each previous ML block is a respective core blockchain transaction and comprises a) a respective data block associated with the data chain, and b) a respective chain output, wherein the respective chain output is configured to be spent by a respective chain input of a subsequent ML block and comprises a locking script configured to implement a respective consensus-based locking mechanism that can be unlocked by any one or more of a plurality of ML block producers, and wherein the method is performed by a ML block producer and comprises:
obtaining a target data block associated with the data chain;
generating a target ML block of the ML blockchain, wherein the target ML block is a respective core blockchain transaction and comprises a) the target data block, and b) a target chain output, wherein the target chain output is configured to be spent by a respective chain input of a subsequent ML block and comprises a locking script configured to implement a respective consensus-based locking mechanism, wherein the respective consensus-based locking mechanism of each respective ML block is a function of the respective data block of that respective ML block, and c) a target chain input that references the respective chain output of a previous ML block and is configured to unlock the respective consensus locking mechanism of that previous ML block; and
causing the target ML block to be recorded on the core blockchain.
